(19) United States
(12) Patent Application Publication
(10) Pub. No.: US 2009/0171738 A1
(43) Pub. Date: Jul. 2, 2009

(54) SERVICE PROVIDING SYSTEM, SERVICE PROVIDING METHOD AND PROGRAM

(75) Inventor: Satoshi NAKAYAMA, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 12/343,520

(22) Filed: Dec. 24, 2008

(30) Foreign Application Priority Data
Dec. 27, 2007 (JP) 2007-336284

(51) Int. Cl. G06Q 10/00; G06Q 30/00

(52) U.S. Cl. 705/8; 705/7; 705/400

(57) ABSTRACT

A service providing system for providing a user with service, includes a service providing unit which provides service, a service provision right storing unit which stores a service provision right necessary for providing the service, and a service provision right manufacturing unit which manufactures the service provision right, wherein the service providing unit includes a function of obtaining the service provision right from the service provision right storing unit to provide service, the service provision right storing unit includes a function of storing the service provision right up to a predetermined storage capacity, and the service provision right manufacturing unit includes a function of manufacturing the service provision right defined by a manufacture amount at a manufacturing interval set in advance.

### TECHNICAL FIELD

The present invention relates to a service providing system for providing service on a flat-rate charging system and, more particularly, a service providing system, a service providing method and a program which enable a service supply to be suppressed.

### BACKGROUND ART

Service charging methods include a time-rate charging system, a meter-rate charging system and a flat-rate charging system.

In communication service, for example, the time-rate charging system is to charge a user according to the amount of time for communication made by the user. This charging system has a shortcoming that because a user is charged only according to communication time irrespective of quantity of communication, the user might be charged even when no communication is made.

The meter-rate charging system is to charge a user according to quantity of communication made by the user. Although this charging system solves the problem of the time-rate charging system, it has a shortcoming that because quantity of communication which is hard to instinctively get hold of is used as a barometer of charging, it is difficult for a user to get hold of a service rate.

The flat-rate charging system is to provide communication by fixed-rate charging. Since this charging system solves the problem of the meter-rate charging system, it is widely adopted in Internet connection service and the like.

Communication services provided by the flat-rate charging system have a problem that resources for the provision of communication services are oppressed by limitless use by users. In Internet connection services in practice, excessive use by a part of heavy users causes such a serious social program as waste of most of resources.

One example of techniques as measures for preventing excessive use of services by a part of users is recited in Patent Literature 1, for example. The technique recited in Patent Literature 1 prevents excessive water (service) use by a part of users by means of water charge meters having a water supply limiting function to stop supply water (service) by closing a water pipe valve when a predetermined volume of water (service) is supplied.

In other words, a possible solution of the above-described problem in the flat-rate charging system is to adopt the system recited in Patent Literature 1 and stop provision of service when in service provision based on the flat-rate charging system, a predetermined service supply for a user is completed.

Patent Literature 1: Japanese Utility-Model Registration No. 3009973

There remains in the method of stopping provision of service to a user upon completion of a predetermined service supply, however, a problem that because continuous service provision is impossible, the original function of service provision cannot be realized as shown in Patent Literature 1.

### THE OBJECT OF THE INVENTION

An object of the present invention, in view of such circumstances as described above, is to provide a service providing method and a service providing system which enable service to be continuously provided while limiting a service supply.

### SUMMARY

According to a first exemplary aspect of the invention, a service providing system for providing a user with service, includes a service providing unit which provides service, a service provision right storing unit which stores a service provision right necessary for providing the service, and a service provision right manufacturing unit which manufactures the service provision right, wherein the service providing unit includes a function of obtaining the service provision right from the service provision right storing unit to provide service, the service provision right storing unit includes a function of storing the service provision right up to a predetermined storage capacity, and the service provision right manufacturing unit includes a function of manufacturing the service provision right defined by a manufacture amount at a manufacturing interval set in advance.

According to a second exemplary aspect of the invention, a service providing method of providing a user with service, including the steps of obtaining the service provision right from a service provision right storing unit for storing a service provision right necessary for providing the service to provide service by a service providing unit for providing service, storing the service provision right up to a predetermined storage capacity by the service provision right storing unit, and manufacturing the service provision right defined by a manufacture amount at a manufacturing interval by a service provision right manufacturing unit for manufacturing the service provision right.

According to a third exemplary aspect of the invention, a computer readable medium storing a program to be executed by a computer on a service providing system for providing a user with service, the program comprising the functions of obtaining the service provision right from a service provision right storing unit for storing a service provision right necessary for providing the service to provide service by a service providing unit for providing service, storing the service provision right up to a predetermined storage capacity by the service provision right storing unit, and manufacturing the service provision right defined by a manufacture amount at a manufacturing Interval by a service provision right manufacturing unit for manufacturing the service provision right.

According to a fourth exemplary aspect of the invention, a service providing system for providing a user with service, includes a providing means for providing service, a storing means for storing a service provision right necessary for providing the service, and a manufacturing means for manufacturing the service provision right, wherein the providing means includes a function of obtaining the service provision right from the storing means to provide service, the storing means includes a function of storing the service provision right up to a predetermined storage capacity, and the manufacturing means includes a function of manufacturing the service provision right defined by a manufacture amount at a manufacturing interval set in advance.

According to the present invention, service can be continuously provided while limiting a service supply.

### BRIEF DESCRIPTION OF THE DRAWINGS

FIG. 1 is a block diagram showing a structure of a service providing system according to a first exemplary embodiment of the present invention;

FIG. 2 is a diagram showing an entire structure of the service providing system according to the first exemplary embodiment of the present invention;

FIG. 3 is a diagram showing operation of a service provision right storing unit and a service provision right manufacturing unit according to the first exemplary embodiment of the present invention;

FIG. 4 is a diagram showing operation of a service providing unit and the service provision right storing unit according to the first exemplary embodiment of the present invention;

FIG. 5 is a diagram showing an operation example according to the first exemplary embodiment of the present invention;

FIG. 6 is a block diagram showing a structure of a service providing system according to a second exemplary embodiment of the present invention;

FIG. 7 is a diagram showing operation in service course change according to the second exemplary embodiment of the present invention;

FIG. 8 is a diagram showing an example of a service course table according to the second exemplary embodiment of the present invention;

FIG. 9 is a diagram showing an example of a schedule table according to the second exemplary embodiment of the present invention;

FIG. 10 is a diagram showing operation of recovering a storage amount and charging according to the second exemplary embodiment of the present invention;

FIG. 11 is a diagram showing an example of a rate table according to the second exemplary embodiment of the present invention;

FIG. 12 is a block diagram showing a structure of a service providing system according to a third exemplary embodiment of the present invention;

FIG. 13 is a diagram showing an example of a storage amount displaying method according to the third exemplary embodiment of the present invention;

FIG. 14 is a block diagram showing a structure of a service providing system according to a fourth exemplary embodiment of the present invention;

FIG. 15 is a diagram showing an example of a service providing method according to the fourth exemplary embodiment of the present invention;

FIG. 16 is a diagram showing an operation example according to the fourth exemplary embodiment of the present invention; and

FIG. 17 is a block diagram showing a hardware structure of a component in each of the exemplary embodiments of the present invention.

### EXEMPLARY EMBODIMENT

Next, exemplary embodiments of the present invention will be described in detail with reference to the drawings.

### First Exemplary Embodiment

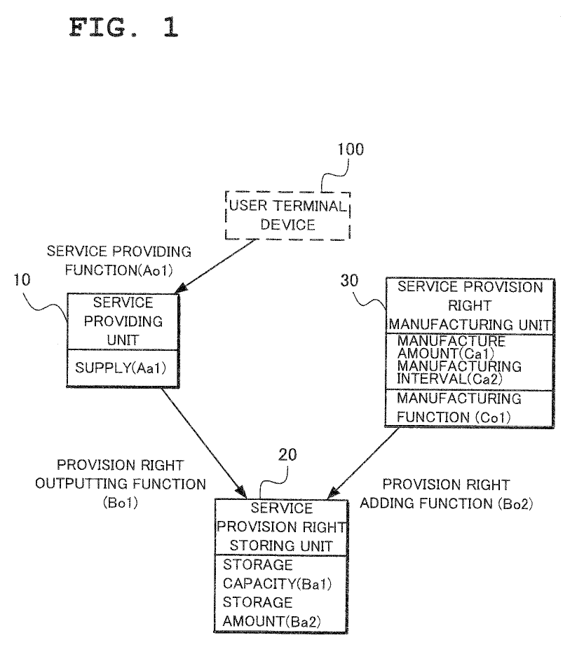

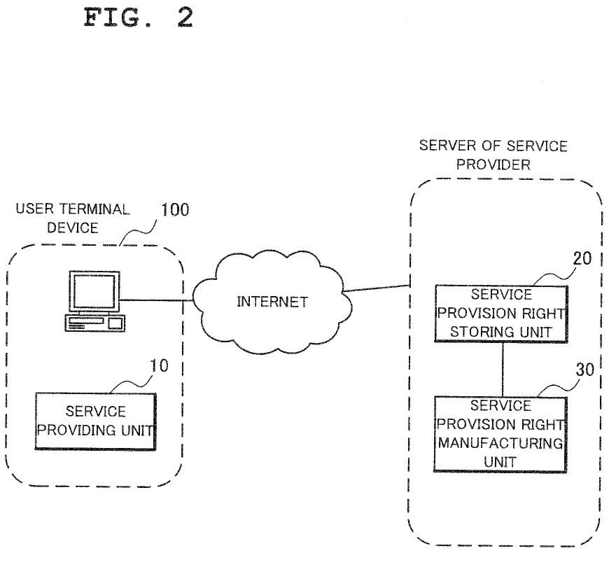

With reference to FIG. 1 and FIG. 2, description will be made of a structure of a service providing system according to a first exemplary embodiment of the present invention.

The continuous service providing system according to the first exemplary embodiment comprises a service providing unit 10 for obtaining a service provision right to provide service, a service provision right storing unit 20 for storing a service provision right up to a certain capacity and a service provision right manufacturing unit 30 for manufacturing a service provision right in every certain time period.

The service providing unit 10 holds a supply (Aa1) indicative of a service supply to a user for one provision right as a parameter and comprises a service providing function (Ao1) of providing a user with service.

In a case of the service providing unit 10 which provides communication service, for example, when a supply is “1 for one packet”, the service providing unit 10 receives one packet from a user terminal device 100 and obtains one service provision right from the service provision right storing unit 20 to transmit one packet.

The service provision right storing unit 20 holds a storage capacity (Ba1) as a limited amount of service provision right which can be stored and a storage amount (Ba2) as an amount of stored service provision right as parameters and comprises a provision right outputting function (Bo1) of outputting a stored service provision right and a provision right adding function (Bo2) of accepting and storing a new service provision right.

When the storage capacity (Ba1) is “10” and the storage amount (Ba2) is “5”, for example, executing provision right output (Bo1) will have the storage amount (Ba2) of 4. Then, repeating the provision right addition (Bo2) results in increasing the storage amount (Ba2) like “5”, “6”, “7” . . . . When the storage amount (Ba2) reaches “10” as the storage capacity (Ba1), abandon a newly accepted service provision right without adding the same or abandon the old service provision right after adding the new right. In addition, when the storage amount is “0”, no provision right output is made by the provision right outputting function (Bo1).

The service provision right manufacturing unit 30 holds a manufacture amount (Ca1) as an amount of service provision right to be manufactured by one manufacturing and a manufacturing interval (Ca2) for calling up a manufacturing function (Co1) at a certain interval as parameters and comprises the manufacturing function (Co1) for manufacturing a service provision right and outputting the manufactured service provision right to the service provision right storing unit 20. When the manufacture amount is 5 and time of the manufacturing interval (Ca2) is one second, for example, five service provision rights are manufactured every one second.

These units are assumed to exist for each user.

Places at which these units are mounted are all arbitrary. It is possible to form these units into one device and also possible to mount each unit in an individual device and connect each device with each other.

In a case of providing communication service, for example, possible is an example of a structure as shown in FIG. 2 in which the service providing unit 10 is mounted on the user terminal device 100 and the service provision right storing unit 20 and the service provision right manufacturing unit 30 on a server of a service provider.

### Operation of the First Exemplary Embodiment

Roughly speaking, the present system has two operations existing in parallel. One is operation for increasing a service provision right along with manufacture of one service provision right and the other is operation for decreasing a service provision right along with provision of service.

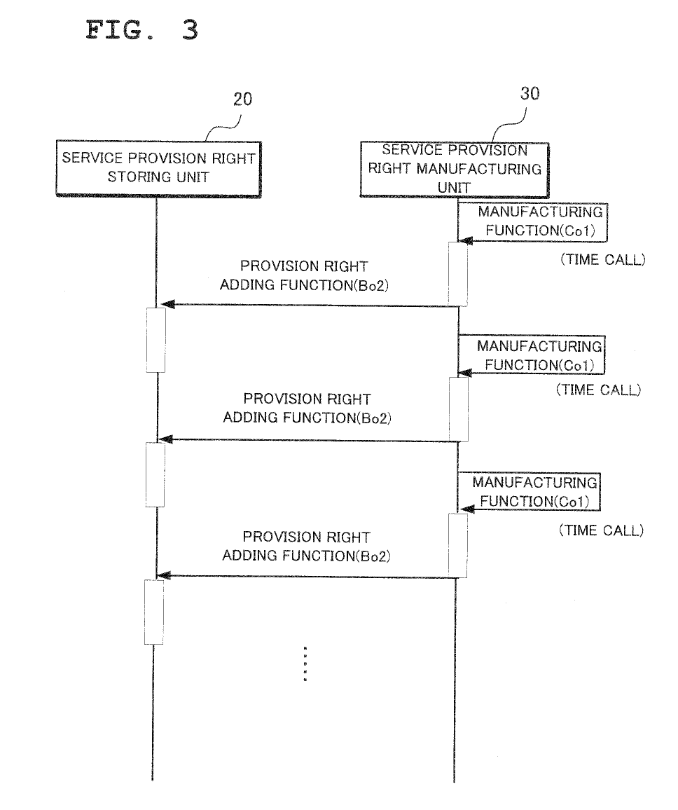

First, the operation for increasing a service provision right will be described with reference to FIG. 1 and FIG. 3.

The service provision right manufacturing unit 30 executes the manufacturing function (Co1) at its own held manufacturing interval (Ca2) to manufacture a service provision right.

The unit also stores the manufactured service provision right in the service provision right storing unit 20 by calling up the provision right adding function (Bo2) of the service provision right storing unit 20. This operation is repeated at an interval of a certain time set as the manufacturing interval (Ca2).

Next, the operation for decreasing a service provision right will be described with reference to FIG. 1 and FIG. 4.

Upon call up of the service providing function (Ao1), the service providing unit 10 calls up the provision right outputting function (Bo1) of the service provision right storing unit 20 to try to obtain a service provision right.

When the service provision right is obtained, the service providing unit 10 is allowed to provide service up to the amount of supply (Aa1) by the service providing function (Ao1). When failing to obtain a service provision right, the unit is not allowed to provide the service.

### EXAMPLE OF OPERATION

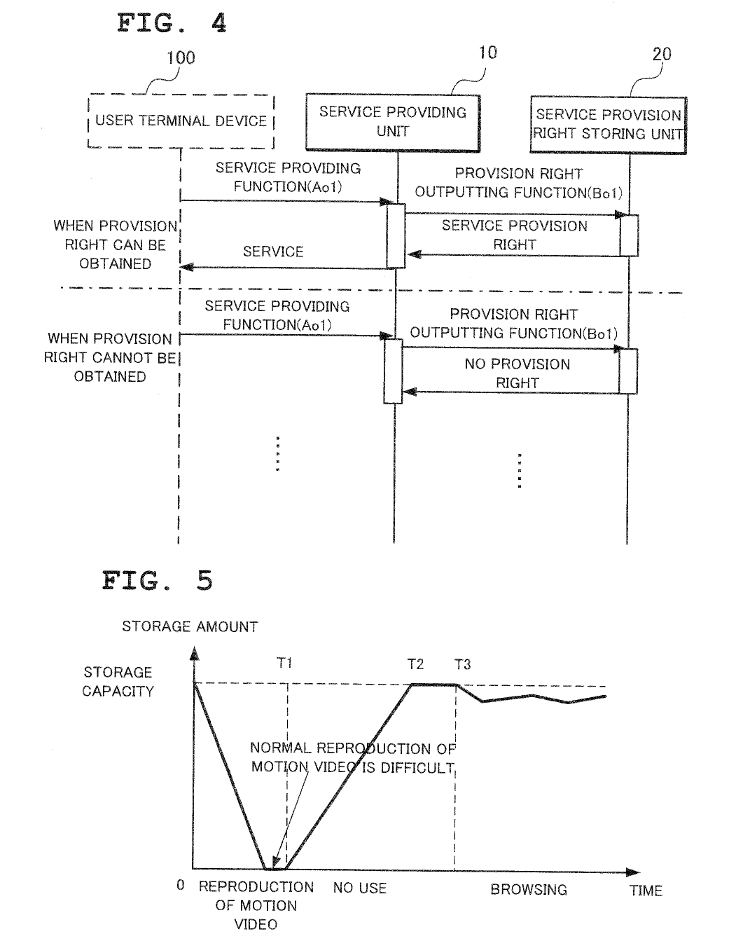

Description will be made of an example of operation in a case where the above-described two operations are executed in parallel with reference to FIG. 1 and FIG. 5. Shown here is an example of operation of a system which provides communication service.

Assume that first; a user reproduces motion video by the user terminal device 100. Then, the service providing unit 10 executes transmission of motion video data for reproducing the motion video. Since motion video data is a large quantity of data, quantities of communication is executed here. When service provision rights are consumed by quantities of communication exceeding a manufacturing rate of the service provision right manufacturing unit 30, the storage amount (Ba2) of the service provision right storing unit 20 is decreased. When the storage amount (Ba2) of the service provision right storing unit 20 goes zero, because the service providing unit 10 is allowed to communicate by a quantity of communication meeting the manufacturing rate of the service provision right manufacturing unit 30, it will be difficult to execute normal reproduction of motion video (reproduction of motion video until time T1 in FIG. 5).

Assume that the user then stops the reproduction of motion video at the user terminal device 100. Then, manufactured service provision rights will be stored in the service provision right storing unit 20 without consumption. When the storage amount (Ba2) reaches the storage capacity (Ba1), no further storage will be executed (no-use from time T1 to time T2 in FIG. 5).

Next, assume that the user executes browsing at the user terminal device 100. Then, the service providing unit 10 executes browsing data communication for browsing. Since browsing data is small in quantity, no large quantity of communication is executed. Therefore, a rate at which a service provision right is consumed and a rate at which a service provision right is manufactured are balanced to prevent the storage amount (Ba2) from changing largely. Accordingly, the user is allowed to continue browsing without a time-limit (browsing from time T3 in FIG. 5).

### Effect of the First Exemplary Embodiment

According to the first exemplary embodiment, service can be provided continuously while limiting a supply of service. The reason is that by providing service while consuming stored service provision rights, a service supply can be limited to the storage amount of the service provision rights and by manufacturing and storing a service provision right at a manufacturing interval as a predetermined time interval, service can be continuously provided.

### Second Exemplary Embodiment

The second exemplary embodiment is expansion of the first exemplary embodiment for the purpose of provision of actual charging service.

With reference to FIG. 6, a structure of a service providing system according to the second exemplary embodiment will be described.

The service providing system according to the present exemplary embodiment comprises, in addition to the components of the continuous service providing system according to the first exemplary embodiment, a service execution amount setting unit 40 for setting a parameter of the service provision right storing unit 20 and the service provision right manufacturing unit 30, and a charging unit 50 for charging for provision of service. Furthermore, the system has new functions which will be described later added to the service provision right storing unit 20 and the service provision right manufacturing unit 30 according to the first exemplary embodiment.

Since the service providing unit 10 is the same as that of the first exemplary embodiment, no description will be made thereof.

The service provision right storing unit 20 comprises, in addition to the same functions as those of the first exemplary embodiment, a storage capacity setting function (Bo3) for changing the storage capacity (Ba1), a storage capacity presenting function (Bo4) for presenting the storage capacity (Ba1) and a storage amount recovering function (Bo5) for recovering the storage amount (Ba2).

The service provision right manufacturing unit 30 comprises, in addition to the same functions as those of the first exemplary embodiment, a manufacture amount setting function (Co2) for changing the manufacture amount (Ca1) and a manufacture amount presenting function (Co3) for presenting the manufacture amount (Ca1).

The service execution amount setting unit 40 holds a service course table (Da1) in which a relationship is described between a service course and a parameter of the course and a schedule table (Da2) for scheduling setting of a parameter and comprises a service course changing function (Do1) for accepting a change of a service course. A parameter of a service course is a value set as the storage capacity (Ba1) and the manufacture amount (Ca1).

The charging unit 50 holds a rate table (Ea1) in which a relationship is described between a parameter set value and a rate and charging information (Ea2) as recording information of charging and comprises a charging function (Eo1) for adding the amount of money to charging information.

While in this example, the manufacture amount (Ca1) is changed, the same effect can be obtained also by a structure in which the manufacturing rate (Ca2) is changed.

### Operation of the Second Exemplary Embodiment

Roughly speaking, this system has two kinds of operations. One is operation of changing a parameter and the other is charging.

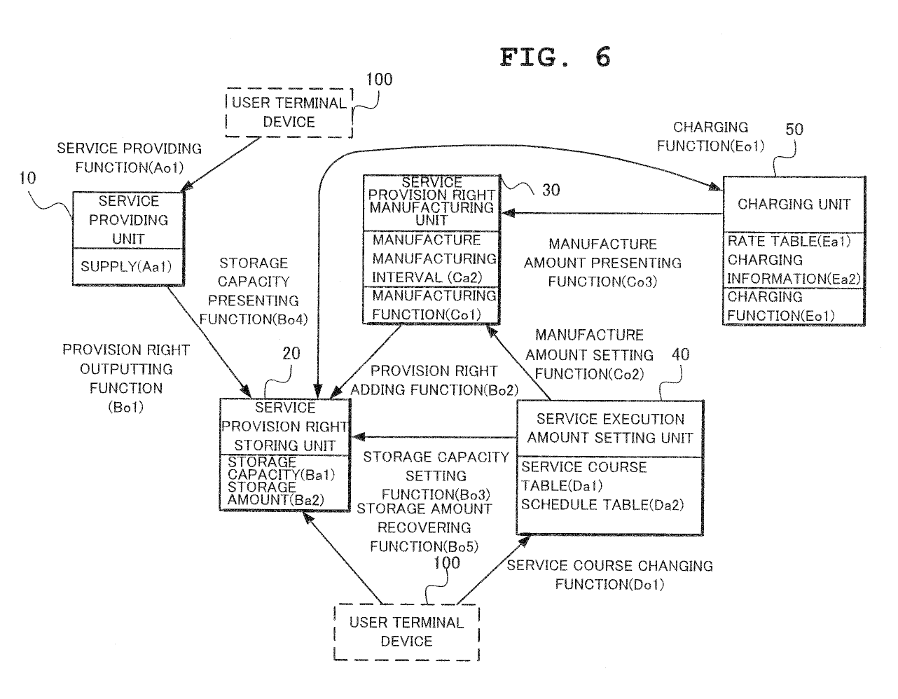

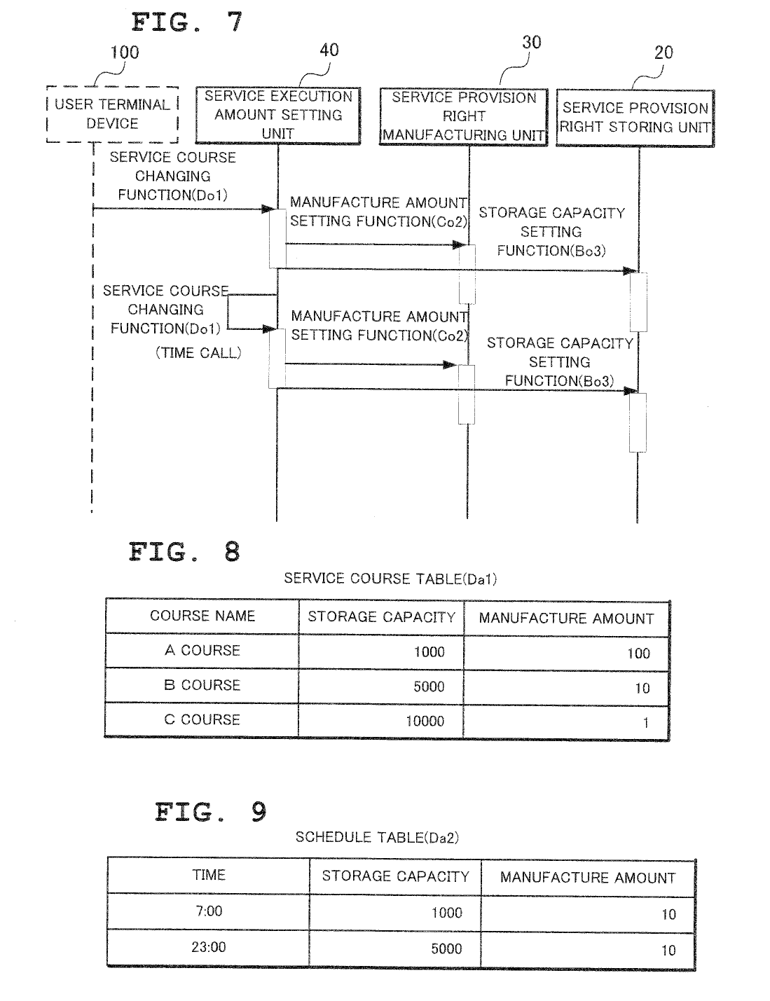

First, the operation of changing a parameter will be described with reference to FIG. 6, and FIG. 7 through FIG. 9.

When having the service course changing function (Do1) called by the user terminal device 100, the service execution amount setting unit 40 refers to the service course table (Da1) to extract a parameter of a service course whose change is designated. Parameters of a service course include values to be set as the storage capacity (Ba1) and the manufacture amount (Ca1). Then, each parameter extracted is set in the service provision right storing unit 20 and the service provision right manufacturing unit 30.

When such a service course table (Da1) as shown in FIG. 8 is held, for example, upon accepting a service course change to a service course B, the service course changing function (Do1) extracts parameters of a storage capacity and a manufacture amount corresponding to the B course from the service course table (Da1) and sets the storage amount of 5000 in the service provision right storage unit 20 and the manufacture amount of 10 in the service provision right manufacturing unit 30. Also generate and hold the schedule table (Da2).

In addition, upon arrival of time written in the schedule table (Da2), the service execution amount setting unit 40 extracts parameters of a storage capacity and a manufacture amount corresponding to the time and sets the same in the service provision right storing unit 20 and the service provision right manufacturing unit 30 similarly to the above-described operation.

When such a schedule table (Da2) as shown in FIG. 9 is held, for example, the storage capacity of 1000 and the manufacture amount of 10 are set upon time 7:00, and the storage capacity of 5000 and the manufacture amount of 10 are set upon time 23:00 in the service provision right storing unit 20 and the service provision right manufacturing unit 30, respectively.

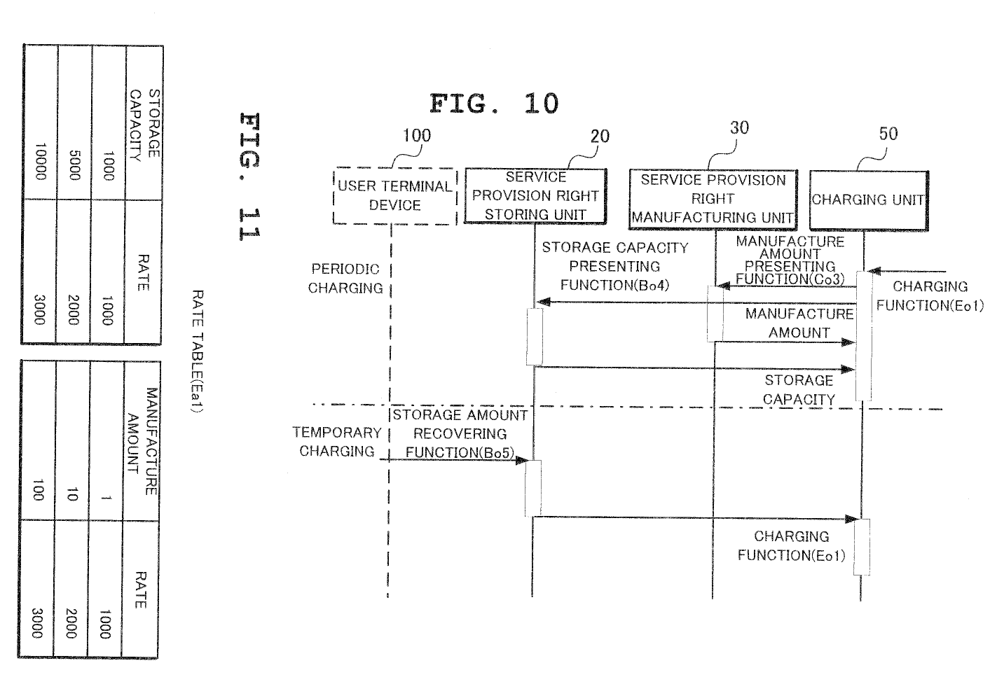

Next, the operation of charging will be described with reference to FIG. 6, FIG. 10 and FIG. 11. The charging operation has two kinds of operation. One is periodic charging operation and the other is temporary charging operation.

First, the periodic charging operation will be described.

When having the charging function (Eo1) called up, the charging unit 50 calls up the manufacture capacity presenting function (Co3) of the service provision right manufacturing unit 30 and calls up the storage capacity presenting function (Bo4) of the service provision right storing unit 20 to obtain the manufacture amount (Ca1) and the storage capacity (Ba1).

The charging function (Eo1) obtains rates corresponding to the obtained storage capacity and manufacture amount from the rate table (Ea1) and writes a rate combining them into the charging information (Ea2).

When such a rate table (Ea1) as shown in FIG. 11 is held, for example, the rate of an A course in FIG. 8 will be the rate of 4000 as a total of the rate 1000 for the storage capacity 1000 and the rate 3000 for the manufacture amount 100. The rate of 4000 is written into the charging information (Ea2).

Next, the temporary charging operation will be described.

When having the storage amount recovering function (Bo5) called up, the service provision right storing unit 20 recovers the storage amount (Ba2) by the amount designated, as well as calling up the charging function (Eo1) of the charging unit 50 to make an additional charge meeting the recovered storage amount. This function is used when a user as a receiver of the service recovers a storage amount of a service provision right by paying an additional fee in emergency.

### Effect of the Second Exemplary Embodiment

The second exemplary embodiment enables, in addition to the above-described effect obtained by the first exemplary embodiment, a storage capacity and a manufacture amount of a service right to be changed in response to a request from a service user or based on a schedule set in advance. It is also possible to temporarily recover a storage amount of service provision right according to user's convenience.

Also possible is to charge according to a storage capacity and a manufacture amount of service provision right, while enabling additional charging in synchronization with temporary recovery of a storage amount.

### Third Exemplary Embodiment

The third exemplary embodiment is expansion of the first exemplary embodiment for the purpose of facilitating a user to visually determine a storage amount of a service provision right.

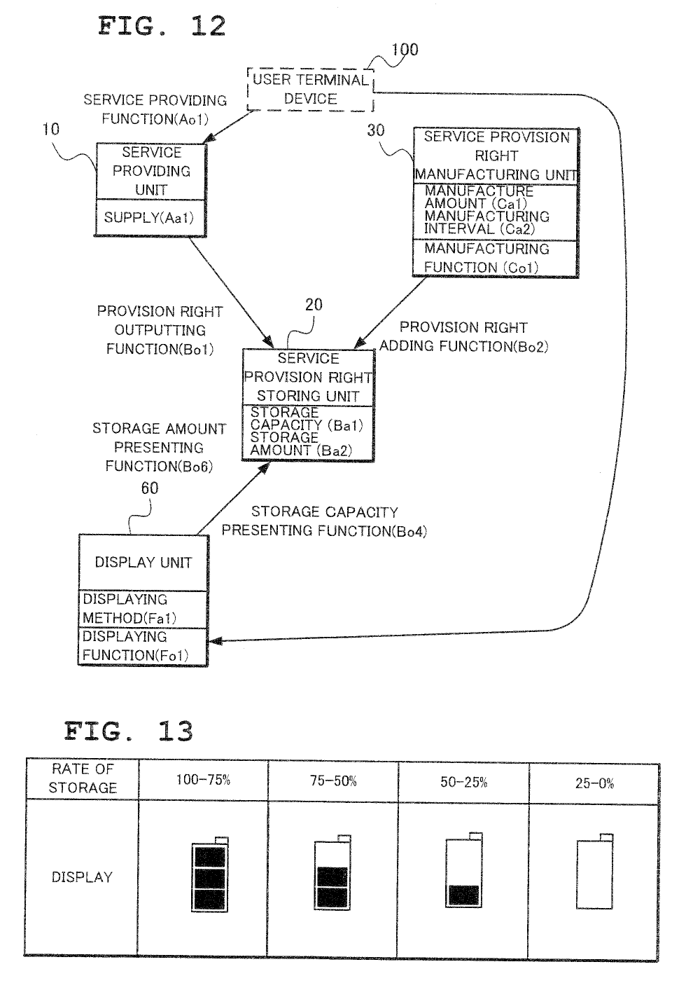

With reference to FIG. 12, a structure of a service providing system according to the third exemplary embodiment will be described.

The service providing system according to the present exemplary embodiment comprises, in addition to the components of the service providing system according to the first exemplary embodiment, a display unit 60. Furthermore, the system has new functions added to the service provision right storing unit 20 in the first exemplary embodiment.

Since the service providing unit 10 is the same as that of the first exemplary embodiment, no description will be made thereof.

The service provision right storing unit 20 comprises, in addition to the same functions as those of the first exemplary embodiment, the storage capacity presenting function (Bo4) for presenting the storage capacity (Ba1) and a storage amount presenting function (Bo6) for presenting the storage amount (Ba2).

Since the service provision right manufacturing unit 30 is the same as that of the first exemplary embodiment, no description will be made thereof.

The display unit 60 holds a displaying method (Fa1) for determining a displaying method as a parameter and comprises a displaying function (Fo1) of displaying a storage amount obtained from the service provision right storage unit 20.

### Operation of the Third Exemplary Embodiment

With reference to FIG. 12, operation of the service providing system according to the present exemplary embodiment will be described.

When having the displaying function (Fo1) called up, the display unit 60 calls up the storage capacity presenting function (Bo4) and the storage amount presenting function (Bo6) of the service provision right storing unit 20 to obtain a storage capacity and a storage amount.

The displaying function (Fo1) calculates a rate of the calculated storage amount to the calculated storage capacity to make a screen display according to the rate of the storage amount calculated by the displaying method (Fa1). As the displaying method (Fa1) possible is such a method as shown in FIG. 13, for example.

### Effect of the Third Exemplary Embodiment

Since the third exemplary embodiment has the effect, in addition to the above-described effect obtained by the first exemplary embodiment, of visual determination of a storage capacity of a service provision right, at the time of using service by a user, the user is allowed to use the determination as a criterion for selecting service.

### Fourth Exemplary Embodiment

The fourth exemplary embodiment is expansion of the first exemplary embodiment for the purpose of controlling a providing method by the service providing unit 10 according to a storage amount of the service provision right storing unit 20.

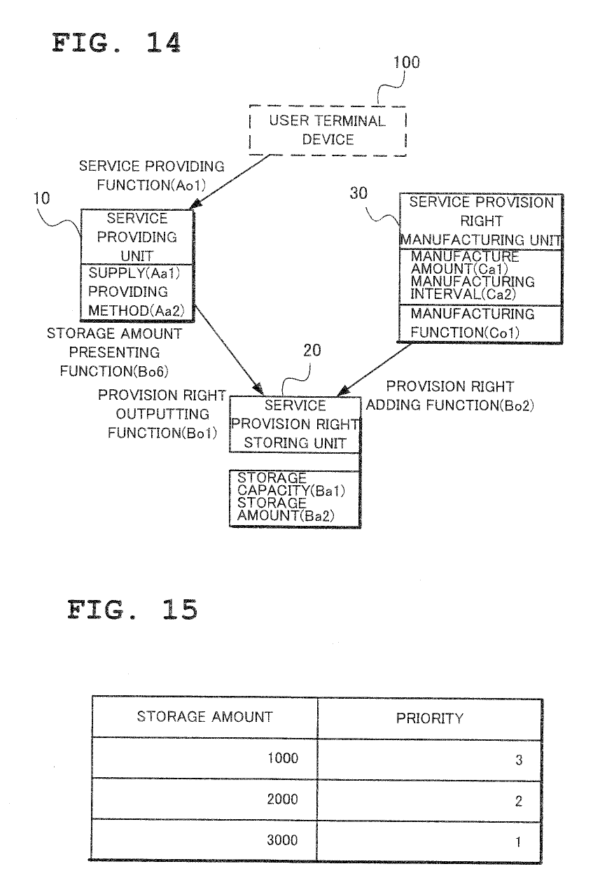

With reference to FIG. 14, a structure of a service providing system according to the fourth exemplary embodiment of the present invention will be described.

The structure of the service providing system according to the present exemplary embodiment is the same as the structure of the continuous service providing system according to the first exemplary embodiment and has new functions which will be described later added to the service providing unit 10 and the service provision right storing unit 20 according to the first exemplary embodiment.

The service providing unit 10 holds, in addition to the same functions as those of the first exemplary embodiment, a providing method (Aa2) for defining a service providing method. Possible as this providing method (Aa2) is, for example, setting service priority according to the amount of storage as shown in FIG. 15.

The service provision right storing unit 20 comprises, in addition to the same functions as those of the first exemplary embodiment, the storage amount presenting function (Bo6) for presenting the storage amount (Ba2).

Since the service provision right manufacturing unit 30 is the same as in the first exemplary embodiment, no description will be made thereof.

### Operation of the Fourth Exemplary Embodiment

Roughly speaking, operation of the present system has two operations in parallel similarly to the first exemplary embodiment. One is operation of increasing a service provision right along with manufacturing of a service provision right and the other is operation of decreasing a service provision right along with service provision. In the present exemplary embodiment, the operation of decreasing a service provision right is expanded out of the two operations and therefore description will be made only thereof.

With reference to FIG. 14, the operation of decreasing a service provision right in the present exemplary embodiment will be described.

When having the service providing function (Ao1) called up, the service providing unit 10 calls up the storage amount presenting function (Bo6) of the service provision right storing unit 20 to obtain the storage amount (Ba2).

The service providing function (Ao1) determines a providing method from the obtained storage amount based on the providing method (Aa2). In a case where such a providing method (Aa2) as shown in FIG. 15 is held, for example, priority of service is determined according to an obtained storage amount. Such manner as setting priority according a storage amount is one example only and other various parameters can be set.

Thereafter, call up the provision right outputting function (Bo1) of the service provision right storing unit 20 to obtain a service provision right. When the service provision right is obtained, the service providing unit 10 is allowed to provide service according to the priority determined by the providing method (Aa2). When no service provision right is obtained, however, no service can be provided.

The service providing unit 10 provides service according to the obtained priority.

In a case of the service providing unit 10 for providing communication service, for example, if high priority can be obtained, service of high communication quality is expected. On the other hand, when obtained priority is low, communication quality might be insufficient.

### OPERATION EXAMPLE

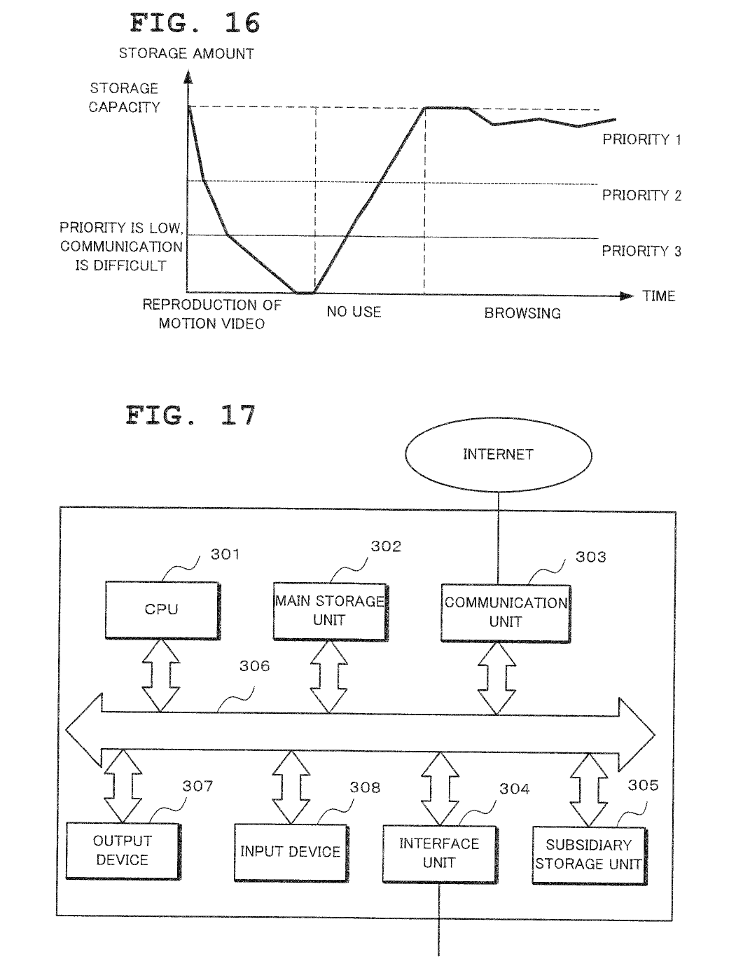

An operation example of the above-described operation will be described with reference to FIG. 16. Shown here is an operation example of a system which provides communication service. Since the system has the operation equivalent to the operation example in the first exemplary embodiment, no detailed description will be made thereof.

As the storage amount of service provision right is decreased, communication priority lowers like 1, 2 and 3. Lowering of priority leads to reduction in quantity of communication to result in reducing the amount of consumption of service provision rights.

### Effect of the Fourth Exemplary Embodiment

Since the fourth exemplary embodiment enables a service providing method to be controlled according to a storage amount in addition the above-described effect obtained by the first exemplary embodiment, high quality service can be provided to a user whose storage amount is large.

Next, description will be made of a hardware structure which realizes the service providing unit 10, the service provision right storing unit 20, the service provision right manufacturing unit 30, the service execution amount setting unit 40, the charging unit 50 and the displaying unit 60 of the service providing system with reference to FIG. 17.

FIG. 17 is a block diagram showing a hardware structure of each of the above-described components.

With reference to FIG. 17, each component can be realized by the same hardware structure as that of a common computer device and comprises a CPU (Central Processing Unit) 301, a main storage unit 302, which is a main memory such as a RAM (Random Access Memory) for use as a data working region or a data temporary saving region, a communication unit 303 for transmitting and receiving data through the Internet, an input/output interface unit 304 (corresponding to a data input/output unit 240) connected to an external device for transmitting and receiving data, a subsidiary storage unit 305 which is a hard disk device formed of a non-volatile memory such as a ROM (Read Only Memory), a magnetic disk or a semiconductor memory, a system bus 306 connecting the above-described respective units of the present information processing device with each other, an output device 307 such as a display device, and an input device 308 such as a keyboard.

Each of the devices according to the present exemplary embodiment can be realized not only in hardware by having a circuit part as a hardware part such as an LSI (Large Scale Integration) mounted which has a program for executing the functions each device has incorporated but also in software by storing a program which provides each function of the service providing unit 10, the service provision right storing unit 20, the service provision right manufacturing unit 30, the service execution amount setting unit 40, the charging unit 50 and the display unit 60 in the subsidiary storage unit 305 and loading the same into the main storage unit 302 to execute the same on the CPU 301.

While the invention has been particularly shown and described with reference to exemplary embodiments thereof, the invention is not limited to these embodiments It will be understood by those of ordinary skill in the art that various changes in form and details may be made therein without departing from the spirit and scope of the present invention as defined by the claims.

### INCORPORATION BY REFERENCE

This application is based upon and claims the benefit of priority from Japanese patent application No. 2007-336284, filed on Dec. 27, 2007, the disclosure of which is incorporated herein in its entirety by reference.

### INDUSTRIAL APPLICABILITY

The present invention is applicable to a system which provides continuous service such as Internet communication service. It is also applicable to a system in which a supply is limited in such service as mail distribution service for preventing quantities of transmission by a part of users.

1. A service providing system for providing a user with service, comprising:
a service providing unit which provides service;
a service provision right storing unit which stores a service provision right necessary for providing said service; and
a service provision right manufacturing unit which manufactures said service provision right; wherein
said service providing unit includes a function of obtaining said service provision right from said service provision right storing unit to provide service,
said service provision right storing unit includes a function of storing said service provision right up to a predetermined storage capacity, and
said service provision right manufacturing unit includes a function of manufacturing said service provision right defined by a manufacture amount at a manufacturing interval set in advance.

2. The service providing system according to claim 1, wherein said service providing unit has a service supply for one service provision right.

3. The service providing system according to claim 1, further comprising a service execution amount setting unit which includes a function of setting at least either a value of the storage capacity of said service provision right storing unit or a value of the manufacture amount of said service provision right manufacturing unit.

4. The service providing system according to claim 3, wherein said service execution amount setting unit includes a service course table which defines at least either the storage capacity of said service provision right storing unit or the manufacture amount of said service provision right manufacturing unit for each course of service.

5. The service providing system according to claim 3, wherein said service execution amount setting unit includes a schedule table for defining time and at least either the storage capacity of said service provision right storing unit or the manufacture amount of said service provision right manufacturing unit, and at said time, defines at least either the storage capacity of said service provision right storing unit or the manufacture amount of said service provision right manufacturing unit based on said schedule table.

6. The service providing system according to claim 1, comprising a charging unit having a function of charging for service provided.

7. The service providing system according to claim 6, wherein said charging unit comprises a rate table which defines a relationship between a value of at least either the storage capacity of said service provision right storing unit or a value of the manufacture amount of said service provision right manufacturing unit and a rate, and obtains a rate to be charged based on said rate table.

8. The service providing system according to claim 1, wherein said service provision right storing unit includes a function of recovering the storage amount of said service provision right according to a request from said user.

9. The service providing system according to claim 8, wherein said charging unit includes a function of, upon recovery of the storage amount by said service provision right storing unit, additionally charging a rate according to the recovered storage amount.

10. The service providing system according to claim 1, comprising a display unit having a function of visually displaying the storage amount of said service provision right storing unit.

11. The service providing system according to claim 1, wherein said service providing unit has a function of changing a service providing method according to the storage amount of said service provision right storing unit.

12. A service providing method of providing a user with service, including the steps of:
obtaining said service provision right from a service provision right storing unit for storing a service provision right necessary for providing said service to provide service by a service providing unit for providing service;
storing said service provision right up to a predetermined storage capacity by said service provision right storing unit; and
manufacturing said service provision right defined by a manufacture amount at a manufacturing interval by a service provision right manufacturing unit for manufacturing said service provision right.

13. The service providing method according to claim 12, wherein said service providing unit provides service according to a service supply for one service provision right.

14. The service providing method according to claim 12, further comprising a service execution amount setting unit, wherein said service execution setting unit sets at least either a value of the storage capacity of said service provision right storing unit or a value of the manufacture amount of said service provision right manufacturing unit.

15. The service providing method according to claim 14, wherein based on a service course table which defines at least either the storage capacity of said service provision right storing unit or the manufacture amount of said service provision right manufacturing unit for each course of service, said service execution amount setting unit sets said storage capacity and said manufacture amount.

16. The service providing method according to claim 14, wherein said service execution amount setting unit sets, based on a schedule table which defines time and at least either the storage capacity of said service provision right storing unit or the manufacture amount of said service provision right manufacturing unit, at least either the storage capacity of said service provision right storing unit or the manufacture amount of said service provision right manufacturing unit at said time.

17. The service providing method according to claim 12, comprising a charging unit, wherein said charging unit obtains a rate to be charged from at least either the storage capacity of said service provision right storing unit or the manufacture amount of said service provision right manufacturing unit.

18. The service providing method according to claim 17, wherein
said service provision right storing unit recovers the storage amount of said service provision right according to a request from said user, and
said charging unit, upon recovery of the storage amount by said service provision right storing unit, additionally charges a rate according to the recovered storage amount.

19. The service providing method according to claim 12, wherein the storage amount of said service provision right storing unit is visually displayed.

20. The service providing method according to claim 12, wherein said service providing unit changes a service providing method according to the storage amount of said service provision right storing unit.

21. A computer readable medium storing a program to be executed by a computer on a service providing system for providing a user with service, said program comprising the functions of:
obtaining said service provision right from a service provision right storing unit for storing a service provision right necessary for providing said service to provide service by a service providing unit for providing service;
storing said service provision right up to a predetermined storage capacity by said service provision right storing unit; and
manufacturing said service provision right defined by a manufacture amount at a manufacturing interval by a service provision right manufacturing unit for manufacturing said service provision right.

22. The program according to claim 21, wherein said service providing unit has a service supply for one service provision right.

23. The program according to claim 21, which causes execution of processing of setting at least either a value of the storage capacity of said service provision right storing unit or a value of the manufacture amount of said service provision right manufacturing unit.

24. The program according to claim 23, which causes execution of processing of, based on a service course table which defines at least either the storage capacity of said service provision right storing unit or the manufacture amount of said service provision right manufacturing unit for each course of service, setting at least either a value of the storage capacity of said service provision right storing unit or a value of the manufacture amount of said service provision right manufacturing unit.

25. The program according to claim 23, which causes execution of processing of, based on a schedule table which defines time and at least either the storage capacity of said service provision right storing unit or the manufacture amount of said service provision right manufacturing unit, defining at least either the storage capacity of said service provision right storing unit or the manufacture amount of said service provision right manufacturing unit at said time.

26. The program according to claim 21, which causes execution of processing of obtaining a rate to be charged based on a rate table which defines a relationship between at least either a value of the storage capacity of said service provision right storing unit or a value of the manufacture amount of said service provision right manufacturing unit and a rate.

27. The program according to claim 21, wherein said service provision right storing unit has processing of recovering the storage amount of said service provision right according to a request from said user.

28. The program according to claim 27, which causes execution of processing of, upon recovery of the storage amount by said service provision right storing unit, additionally charging a rate according to the recovered storage amount.

29. The program according to claim 21, which causes execution of processing of visually displaying the storage amount of said service provision right storing unit.

30. The program according to claim 21, wherein said service providing unit has processing of changing a service providing method according to the storage amount of said service provision right storing unit.

31. A service providing system for providing a user with service, comprising:
a providing means for providing service;
a storing means for storing a service provision right necessary for providing said service; and
a manufacturing means for manufacturing said service provision right; wherein
said providing means includes a function of obtaining said service provision right from said storing means to provide service,
said storing means includes a function of storing said service provision right up to a predetermined storage capacity, and
said manufacturing means includes a function of manufacturing said service provision right defined by a manufacture amount at a manufacturing interval set in advance.
